(19) United States
(12) Patent Application Publication
(10) Pub. No.: US 2003/0188185 A1
(43) Pub. Date: Oct. 2, 2003

(54) System and method for issuing user configurable identification numbers with collision free mapping

(75) Inventors: Dwip N. Banerjee, Austin, TX (US); Rabindranath Dutta, Los Angeles, CA (US)

Correspondence Address: Edmond A. DeFrank, 20145 Via Medici, Northridge, CA, 91326, US

(73) Assignee: International Business Machines Corporation, Armonk, NY

(21) Appl. No.: 10/112,480

(22) Filed: Mar. 28, 2002

(51) Int. Cl. H04L 9/00

(52) U.S. Cl. 713/200

(57) ABSTRACT

The present invention is embodied in a system and method for enhancing system privacy and security identification of electronic devices and computer systems. In general, in one embodiment, the present invention issues user configurable unique identification numbers (IDs) with collision free mapping for electronic and computer devices. The originally issued IDs are generated with sufficient distance between each other to ensure collision free generation when users later transform the original IDs into new respective unique IDs.

### BACKGROUND OF THE INVENTION

1. Field of the Invention

The present invention relates in general to identification and security of electronic devices and computer systems, and more particularly to a method and system for issuing user configurable unique identification numbers (IDs) with collision free mapping for electronic and computer devices.

2. Related Art

Associating a unique serial number or unique identification number with an electronic product or a person allows secure communications between that product or person. For example, having a unique identification number associated with a specific user can be useful in certified transactions. Namely, the user can prove their identity because no two unique identification numbers are the same. Government agencies (for example, the social security office) have been issuing unique identification numbers to people for years to specifically associate a person with sensitive information relating to that person.

In the general electronics field, manufacturers of car radios have made theft of the products unprofitable with built-in unique identification numbers. The unique identification number is associated with the car or the user and transforms the radio into a useless device if it is removed from the associated vehicle. This unique identification system deters and reduces the theft of car radios.

In the computer field, central processing units (CPUs), software and hardware devices can be identified with unique associated identification numbers. The unique number can be used to locate or identify the user with the device to aid in the licensing of that device or devices that work with that device. This helps prevent copyright violations. For example, a software product can require registration of a CPU's or computer system's assigned unique identification number in order to allow the software to run on the computer properly. Once the software is registered with the particular CPU or computer, it cannot run on other CPUs or computers because the other CPUs or computers will have non-matching or different identification numbers than the registered CPU or computer.

Another use of unique identification numbers is in the computer network field. Computers networks are widespread and play an integral role in the function of business, government, and education etc. In general, a computer network is two or more computers, or associated devices, which are connected by a communication system. A computer network may include a server, which is a computer that provides shared resources to users of the network, and a client system comprised of a plurality of computers that access the shared network using the communication system.

Typical network computing applications involve the use of unique addresses, such as media access control (MAC) addresses, in network cards and personal computers. The MAC address is a hardware address that uniquely identifies each network card or node of a network. Computer systems that use MAC addresses are established and setup to uniquely identify each computer using the particular card. However, establishment of a unique MAC address is not flexible and cannot be changed without hardware modifications that may involve the replacement of the central processing unit (CPU) and/or the network card.

In local area networks (LANs) that use MAC addresses, every node or user has a unique address, and on the Internet every file has a unique address or URL (uniform resource locator). Each URL is unique and is a global address of a document that has two parts, the first part indicates the protocol to be used, for example FTP or HTTP, and the second part has the actual unique IP address.

In the network domain, Internet protocol creates link-local addresses from a 64 bit interface ID (EUI-64) which, in turn, is constructed from a 48-bit MAC address using a specific mapping function. While this creates globally unique addresses and facilitates auto-configuration of addresses, it also generates privacy concerns. Namely, the mapping is one-to-one and does not address privacy issues. In some cases, this could allow someone to track all network activity of a certain adapter, which, as discussed above, is difficult to change.

Nevertheless, these systems are limited and have drawbacks. Namely, they do not accommodate user controlled or requested changes to the unique identification number in case of theft or exposure of the unique number. In addition, privacy violators and computer hackers, such as illegal copyists, can usually easily break into a user's secure computing environment if they know how a manufacturer originally sets unique IDs. The computer hacker's first goal is to get access to a user's network in order to read the user's files by determining the user's unique IDs.

Once inside the user's computing system, the hacker's second goal is to find a technical weakness, such as root access. Root access means the hacker has unrestricted access to the inner workings of the system. With this access, the hacker can copy, change or delete any files, authorize new users, change the system to conceal the hacker's presence, install a way to allow regular future access without going through log-in procedures and even add a module to capture the user IDs and passwords of everyone who accesses the system. Use of the captured user IDs and passwords eventually allows an attack of the networks of other organizations to which the captured user IDs and passwords provide approved access.

Therefore what is needed is a method and system designed to create initial unique identification numbers (IDs) and allow transformation of these initial set of unique IDs into a new set of unique IDs without collisions between the newly transformed IDs of different users and under the control of the user that is difficult for a computer hacker to determine. Further, what is needed is the above system and method that will allow the user to periodically change the unique IDs for providing additional security and privacy.

### SUMMARY OF THE INVENTION

To overcome the limitations in the prior art described above, and to overcome other limitations that will become apparent upon reading and understanding the present specification, the present invention is embodied in a system and method for identification and security of electronic devices and computer systems. This is accomplished by issuing user configurable unique identification numbers (IDs) with collision free mapping for electronic and computer devices. The originally issued IDs are generated with sufficient distance between each other to ensure collision free generation when users later transform the original IDs into new respective unique IDs.

In general, a device, such as a device of a computing environment is assigned a unique identification number (ID) or hardware address during production of the device that uniquely identifies the device and to uniquely identify the computer system using the particular device. During production of the device that will use the unique ID, the associated manufacturer generates the unique ID from a binary numbering process with a defined bit set or sequence. The numbers are selected from a set of binary numbers that are at least 2k+1 distance apart from each other, where k is preferably a randomly large integer bit factor that is greater than 0. This allows each unique ID to be transformable at a later time without hardware modifications and that are non-colliding.

In particular, when a user decides to transform the unique ID, a unique ID change module can be used. The change module is preferably a software application running on the computing system. The unique ID change module can use a graphical user interface to allow user-friendly interaction and changing of the original unique ID assigned by the manufacturer. The user can change the original unique ID up to k bits. Since the numbers originally selected by the manufacturer were selected from a set of binary numbers that are at least 2k+1 distance apart from each other, the creation of a new unique ID of the user is non-colliding with other unique IDs that are changed by other users of the device made by the manufacturer.

With the system and methods of the present invention, users can select their own unique IDs that will not collide with other users of devices made by the same manufacturer. Also, the initial ID assigned to each user is difficult to determine by a computer hacker if the manufacturer chooses a k value that is random and large. Further, the advantages of unique IDs are maintained while gaining the flexibility to change the IDs without collision with other devices and without compromising privacy or security.

The present invention as well as a more complete understanding thereof will be made apparent from a study of the following detailed description of the invention in connection with the accompanying drawings and appended claims.

### DETAILED DESCRIPTION OF THE INVENTION

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

Referring now to the drawings in which like reference numbers represent corresponding parts throughout:

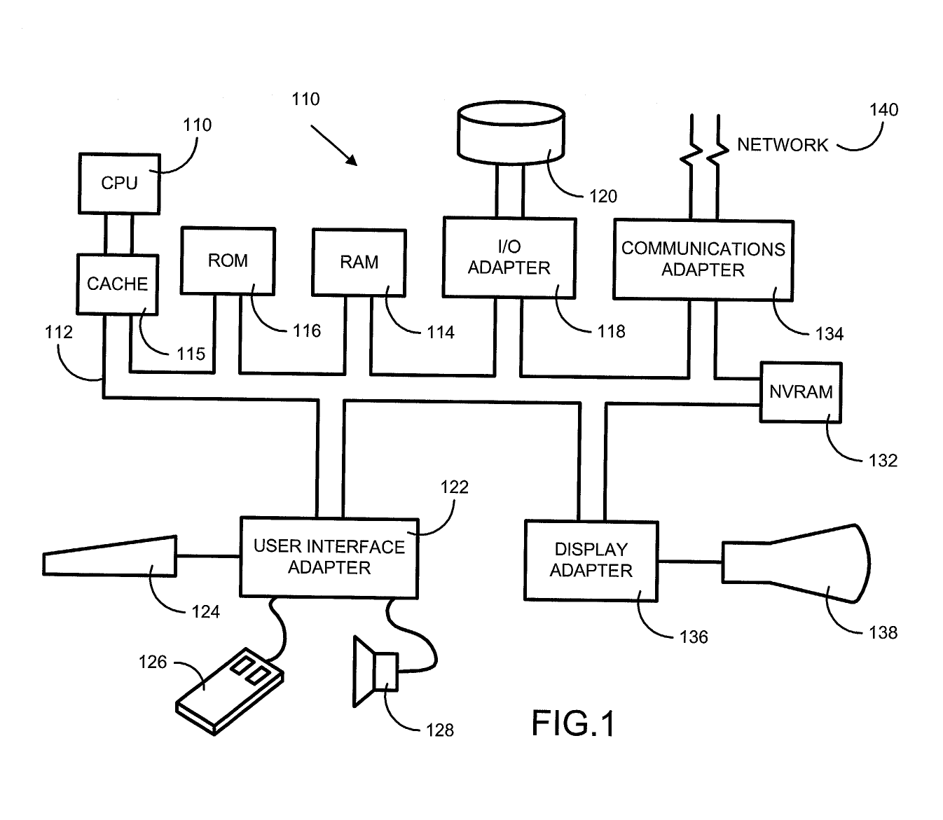

FIG. 1 illustrates a conventional hardware configuration for use with the present invention.

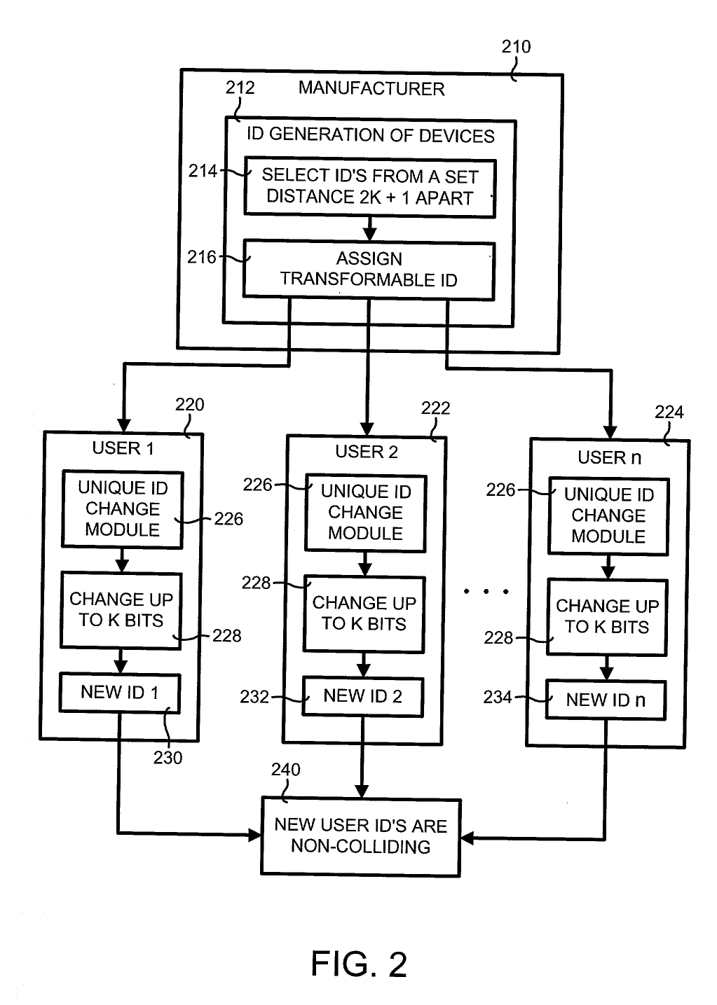

FIG. 2 is a block diagram illustrating the system of the present invention.

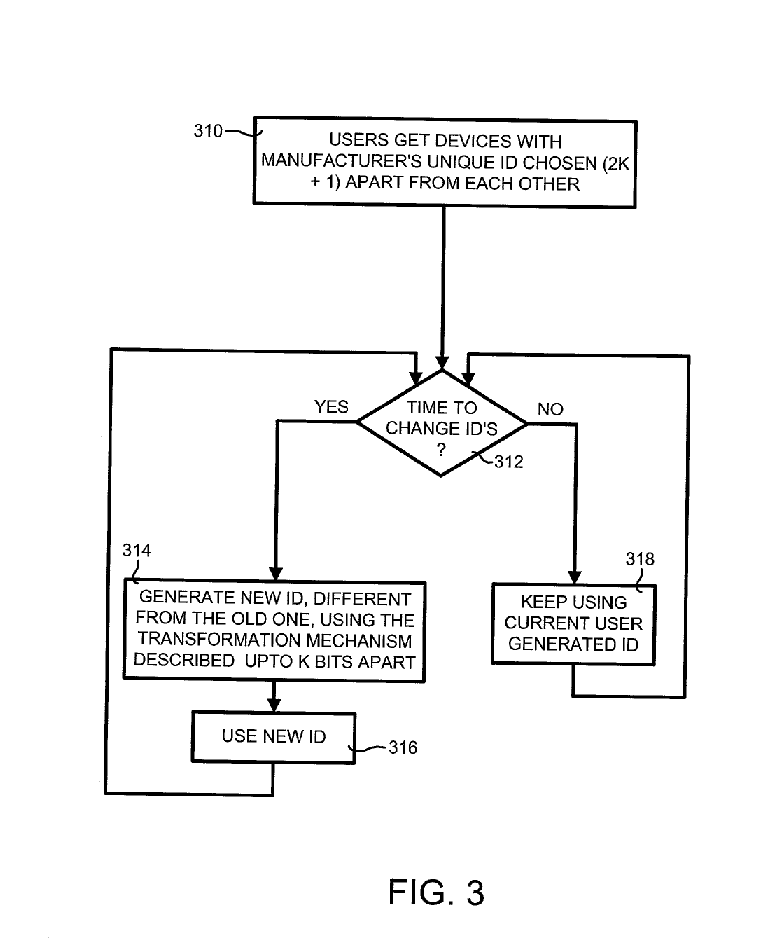

FIG. 3 is a flow chart illustrating the operation of the present invention.

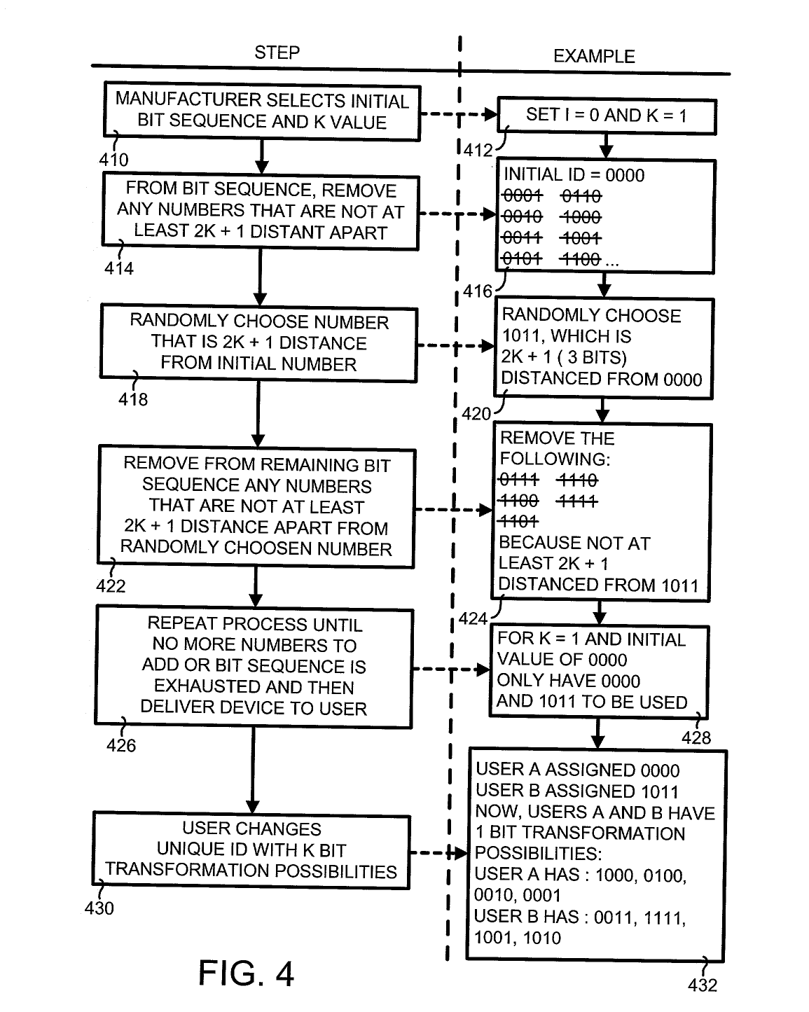

FIG. 4 is a flow chart illustrating the operation of a working example of the system of the present invention.

### DETAILED DESCRIPTION OF THE INVENTION

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

I. Exemplary Environment

The preferred embodiments may be practiced in any suitable hardware configuration that uses a networked connection, such as computing system 100 illustrated in FIG. 1 or alternatively, in a laptop or notepad computing system. Computing system 100 includes any suitable central processing unit 110, such as a standard microprocessor, and any number of other objects interconnected via system bus 112.

For purposes of illustration, computing system 100 includes memory, such as read only memory (ROM) 116, random access memory (RAM) 114, Non-Volatile Random Access Memory (NVRAM) 132 and peripheral memory devices (e.g., disk or tape drives 120) connected to system bus 112 via I/O adapter 118. The cache 115 is a special section of random access memory. Computing system 100 further includes a display adapter 136 for connecting system bus 112 to a conventional display device 138. Also, user interface adapter 122 could connect system bus 112 to other user controls, such as keyboard 124, speaker 128, mouse 126, and a touch pad (not shown). In addition, the system 100 can be connected via a communications adapter 134 to a network 140.

One skilled in the art readily recognizes how conventional computers and computer programs operate, how conventional input device drivers communicate with an operating system, and how a user conventionally utilizes input devices to initiate the manipulation of objects in a graphical user interface.

A graphical user interface (GUI) and operating system (OS) of the preferred embodiment reside within a computer-readable media and contain device drivers that allow one or more users to initiate the manipulation of displayed object icons and text, on a display device. Any suitable computer-readable media may retain the GUI and OS, such as ROM 116, RAM 114, disk and/or tape drive 120 (e.g., magnetic tape or diskette, CD-ROM, optical disk, or other suitable storage media).

In the preferred embodiment, the GUI may be viewed as being incorporated and embedded within the operating system. Alternatively, any suitable operating system or desktop environment could be utilized.

II. General Overview

FIG. 2 is a block diagram illustrating the system of the present invention. Referring to FIG. 1 along with FIG. 2, some of the devices of computing system 100 use unique identification numbers (ID), which can be media access control (MAC) addresses for communications adapter 134 or CPU IDs for processor 110. The MAC address is a hardware address that uniquely identifies each communications adapter 134. As such, in computing system 100, the unique ID or MAC address is established and setup to uniquely identify computer system 100 using the particular communications adapter 134.

During production of each device that will use a unique ID, the associated manufacturer 210 generates a unique ID 212 for each device during production of that device. The unique ID is assigned and issued to the device, which preferably has a rewriteable bios (basic input/output system that can be placed in a RAM chip of the device) memory to store the unique ID. Since current generation of unique IDs are not flexible and cannot be changed at a later time without hardware modifications that may involve the replacement of the central processing unit (CPU) 110 and/or the communications adapter 134, the present invention allows the manufacture to generate the unique ID from a binary numbering process with a defined bit set or sequence.

The devices are originally assigned unique identification numbers so that the numbers are sufficiently distanced apart from each other by a predefined amount to prevent future collisions. In one embodiment, the numbers are selected from a set of binary numbers that are at least 2k+1 distance apart 214 from each other, where k is preferably a randomly large integer bit factor that is greater than 0. This allows each unique ID to be transformable 216 at a later time without hardware modifications and that are non-colliding.

Each user 220, 222, 224 (user 1, user 2 and user n) is provided with a unique ID change module 226, which is preferably a software application running on the computing system 100. In general, the change module 226 can have a calculate module with a transformation relationship that is mathematically related to a spacing relationship used by a manufacturer to originally issue the unique identification number that will not collide with other future generated identification numbers. The change module 226 can also have a transform module that changes the original identification number to a new identification number by determining all possible identification numbers that will not collide with other future generated identification numbers.

In particular, the change module 226 includes a transformation algorithm that is mathematically related to the 2k+1 spacing relationship used by the manufacturer. Namely, the software application uses the mathematical spacing relationship to transform the original ID to a new ID by determining all of the possible IDs that the user can choose with, for instance, a k bit transformation, that will not collide with other users of other devices of the same manufacturer. This is discussed in detail in the working example described with reference to FIG. 4. The new transformed ID is preferably randomly chosen and then provided to the user.

The unique ID change module can use a graphical user interface that is coupled to the rewriteable bios memory of the device to allow user-friendly interaction and changing of the original unique ID assigned by the manufacturer 216. The users 220, 222, 224 can change their respective original unique IDs up to k bits 228. Since the numbers originally selected by the manufacturer were selected from a set of binary numbers that are at least 2k+1 distance apart 214 from each other, the creation of new unique ID1 230, unique ID2 232 and unique IDn 234 of user 1, user 2 and user n (222, 224, and 226), respectively, are non-colliding with each other.

III. Details of the Components and Operation

FIG. 3 is a flow chart illustrating the operation of the system of the present invention. First, for each user, the user gets a device with the manufacturer's unique ID chosen (2k+1) apart from each other (step 310). Second, it is determined whether it is time to change the unique IDs (step 312). For example, the user may have experienced an attempt to break into the user's computing system, the user may have been using the unique ID for too long or some other suitable user defined event has occurred. If so, third, each user can apply transformation of the unique ID (up to k bits) to produce secure new unique ID for the device that is different than the old unique ID (step 314).

The new unique ID is used by the user (step 316) and is non-colliding with other unique IDS generated by other users because the manufacturer originally selected numbers for the unique ids from a set of binary numbers that are at least 2k+1 distance apart 214 from each other. The process repeats to step 312. If the user decides not to change the unique ID (step 312), the current unique ID is kept (step 318), which is also non-colliding with other unique IDs generated by other users because the manufacturer originally selected numbers for the unique IDs from a set of binary numbers that are at least 2k+1 distance 214 from each other.

The method and system of the present invention is useful to keep computer thieves, commonly know as illegal cryptologists or computer hackers, from breaking into a user's secure computing environment. The computer hacker's first goal is to get access to a user's network in order to read the user's files. The computer hacker attempts to determine the user's unique ID.

Once inside the computing system, the hacker's second goal is to get what is called “root” access. That usually requires finding a technical weakness, such as root access. Root access means the hacker has unrestricted access to the inner workings of the system. With root access the hacker can copy, change or delete any files, authorize new users, change the system to conceal the hacker's presence, install a “back door” to allow regular future access without going through log-in procedures and even add a “sniffer” to capture the user IDs and passwords of everyone who accesses the system. Use of the captured user IDs and passwords eventually allows an attack of the networks of other organizations to which the captured user IDs and passwords provide approved access.

However, in the case of the present invention, a computer hacker will have a difficult time trying to guess the newly transformed unique ID even if the computer hacker knows how a manufacturer originally assigns unique IDs. This is because if the user generated a new unique ID different from the original manufacturer's ID, the user generated new unique ID is k bits different from the original unique ID. The computer hacker will have a difficult time determining the new unique ID because there will probably be too many options to change, namely, up to k bits.

Therefore, with the system and methods of the present invention, users can select their own unique IDs that will not collide with other users of devices made by the same manufacturer. Also, the initial ID assigned to each user is difficult to determine by a computer hacker if the manufacturer chooses a k value that is random and large. Further, the advantages of unique IDs are maintained while gaining the flexibility to change the IDs without collision with other devices and without compromising privacy or security.

IV. Working Example

FIG. 4 is a flow chart illustrating the operation of a working example of the system of the present invention. For illustrative purposes only, in this working example the device is a computer device that works with computing system 100 of FIG. 1. The process is shown on the left side and separated from the example on the right side by dotted lines. It should be noted that portions of the working example are preferably accomplished automatically with a software application programmed in accordance with the present invention.

First, the manufacturer selects an initial bit sequence and k value for the device during production of the device (step 410). In this example, for simplistic purposes, the k value equals 1 (step 412) for binary numbers 0-15. Second, from the bit sequence, any numbers that are not at least 2k+1 distant apart from each other are removed (step 414). For k=1, the initial unique ID is set at 0000 and all other numbers that are within 2k+1 bits from 0000 are removed, as shown by step 416.

Third, a number that is 2k+1 distance from the initial number is randomly chosen as the next unique ID that can be assigned to a device (step 418). In this example, 1011 is randomly chosen, which is 2k+1 bits (3 bits) distanced from 0000 (step 420). Fourth, any numbers that are not at least 2k+1 distance apart from randomly chosen number are removed from the remaining bit sequence (step 422). As shown in step 424, every number in the bit sequence that is not at least 2k+1 spaced from random number 1011 is removed from the bit sequence. Fifth, the process is repeated until no more numbers can be added or the bit sequence is exhausted and then the devices can be delivered to end users (step 426). In this example, for k=1 and an initial value of 0000, as shown in FIG. 4, the only unique IDs that can be used with this particular bit sequence are 0000 and 1011 (step 428).

Next, the users of the devices assigned the original unique IDs can change their respective unique IDs with k bit transformation (step 430). In this example, user A has the device with unique ID 0000 and user B has the device with unique ID 1011. Since k=1, the possible selectable IDs by user A is 1000, 0100, 0010 and 0001 while the selectable IDs for user B are 0011, 1111, 1001 and 1010. Mathematically, since the two initial IDs have a distance of 2k+1 bits apart (3 bits), the possible transformed new IDs of user A and user B will not collide as shown in step 432.

By having initial IDs, which differ by a distance of 2k+1 where k is an arbitrarily large number and allowing users the privilege of modifying k bits, it becomes very difficult for an illegal crypto analyst or computer hacker to recover the initial IDs of users. Further, the manufacturer can select the initial IDs via a certain degree of randomization to make it even more difficult for computer hackers.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for securely identifying a device with a unique identification number, the method comprising:
originally assigning the unique identification number to the device so that the number is sufficiently distanced apart from other unique identification numbers of other devices by a predefined amount to prevent future collisions of future generated numbers; and
allowing the unique identification number to be changed by a portion of the predetermined amount.

2. The method of claim 1, wherein the number is determined by a relationship 2k+1, wherein k is an integer equal to at least 1.

3. The method of claim 2, wherein the predetermined amount is k and the portion of the predetermined amount is an integer equal to at least 1.

4. The method of claim 1, wherein the number is used as a media access control address for a network interface card of a computer system.

5. The method of claim 1, wherein the number is used as an identification serial number for a central processing unit of a computer system.

6. The method of claim 1, wherein originally assigning the unique identification number to the device includes to writing the unique number to a rewriteable bios memory of the device.

7. The method of claim 1, further comprising using a software application of a computer system to allow a user of the device to change the unique identification number by a portion of the predetermined amount.

8. The method of claim 7, wherein the software application includes a graphical user interface that is coupled to the rewriteable bios memory of the device.

9. The method of claim 1, wherein originally assigning the unique identification number to the device is performed during production and manufacturing of the device.

10. A method for securely identifying devices in a computer system, the method comprising:
defining a relationship to generate unique numbers for the devices that are sufficiently distanced apart from one another to prevent future collisions between future generated numbers;
generating and issuing an original unique identification number for each device based on the defined relationship; and
transforming originally issued unique identification numbers of respective devices by a portion of the predetermined amount.

11. The method of claim 10, wherein the relationship is 2k+1, wherein k is an integer equal to, at least 1 and the predetermined amount is k and the portion of the predetermined amount is an integer equal to at least 1.

12. The method of claim 10, wherein originally assigning the unique identification number to the device includes to writing the unique number to a rewriteable bios memory of the device.

13. The method of claim 12, further comprising using a software application of a computer system to allow a user of the device to change the unique identification number by a portion of the predetermined amount.

14. The method of claim 13, wherein the software application includes a graphical user interface that is coupled to the rewriteable bios memory of the device.

15. The method of claim 10, wherein originally assigning the unique identification number to the device is performed during production and manufacturing of the device.

16. An information handling system for transforming originally issued unique identification numbers of a device, the system comprising:
a calculate module with a transformation relationship that is mathematically related to a spacing relationship used by a manufacturer to originally issue the unique identification number that will not collide with other future generated identification numbers; and
a transform module that changes the original identification number to a new identification number by determining all possible identification numbers that will not collide with other future generated identification numbers.

17. The user interface of claim 16, wherein the spacing relationship is 2k+1, wherein k is an integer equal to at least 1.

18. The user interface of claim 16, wherein the device includes a rewriteable bios memory to store the originally assigned unique identification number.

19. The user interface of claim 18, wherein the rewriteable bios memory stores the transformed unique identification number.

20. The user interface of claim 16, wherein the device is at least one of a media access control address for a network interface card of a computer system or an identification serial number for a central processing unit of a computer system.

21. A method using a computer-readable medium having computer-executable instructions for securely identifying a device with a unique identification number, the method comprising:
allowing a user to change the unique identification number by a portion of a predetermined amount, wherein the unique identification number was originally assigned to the device as a unique number that was sufficiently distanced apart from other unique identification numbers of other devices by a predefined amount to prevent future collisions of future generated numbers.

22. The method of claim 21, wherein the number is determined by a relationship 2k+1, wherein k is an integer equal to at least 1.

23. The method of claim 22, wherein the predetermined amount is k and the portion of the predetermined amount is an integer equal to at least 1.

24. The method of claim 21, wherein the originally assigned unique identification number was written to a rewriteable bios memory of the device.

25. The method of claim 21, further comprising using a software application to allow the user of the device to change the unique identification number by a portion of the predetermined amount.

26. The method of claim 21, wherein the unique identification number is originally assigned to the device during production and manufacturing of the device.
